(19) United States
(12) Patent Application Publication
(10) Pub. No.: US 2016/0077414 A1
(43) Pub. Date: Mar. 17, 2016

(54) LIGHT SOURCE DEVICE AND VIDEO DISPLAY APPARATUS

(71) Applicant: Panasonic Intellectual Property Management Co., Ltd., Osaka (JP)

(72) Inventors: Yumeto NISHIYAMA, Osaka (JP); Kazunori TANABE, Osaka (JP); Masato TANAKA, Kyoto (JP)

(21) Appl. No.: 14/850,585

(22) Filed: Sep. 10, 2015

(30) Foreign Application Priority Data
Sep. 11, 2014 (JP) 2014-184958
Jul. 30, 2015 (JP) 2015-150190

(51) Int. Cl. G03B 21/16; G03B 21/00; H04N 9/31; F21V 29/503

(52) U.S. Cl. CPC G03B 21/16; F21V 29/503; G03B 21/008; H04N 9/3144

(57) ABSTRACT

A light source device includes a light source having a light emitting element, a thermal conductor, an optical system housing, and a cooler. The thermal conductor has a first surface and a second surface, and the light source is thermally connected to the first surface. The optical system housing has a mounting part with an opening. The thermal conductor is fixed to the optical system housing in a state that the first surface is disposed in a direction facing the mounting part and the light emitting element is disposed at a position facing the opening. The cooler is thermally connected to the second surface of the thermal conductor and cools heat from the light source.

### BACKGROUND

1. Field of the Disclosure

The present disclosure relates to a light source device including a cooling mechanism and a video display apparatus including the light source device.

2. Background Art

Unexamined Japanese Patent Publication No. 2007-24939 (PTL 1) discloses a light source device. This light source device includes a light source, a heat absorption block, a heat radiation means, and a heat transport means. In this light source device, heat generated in the light source is absorbed by the heat absorption block. The heat absorbed by the heat absorption block is transmitted to the heat radiation means by the heat transport means and is then radiated into the air.

### SUMMARY

The present disclosure provides a light source device capable of improving maintainability of a cooler for cooling a light source.

A light source device in one aspect of the present disclosure includes a light source having a light emitting element, a thermal conductor, an optical system housing, and a cooler. The thermal conductor has a first surface and a second surface, and the light source is thermally connected to the first surface. The optical system housing has a mounting part with an opening. The thermal conductor is fixed to the optical system housing in a state that the first surface is disposed in a direction facing the mounting part and the light emitting element is disposed at a position facing the opening. The cooler is thermally connected to the second surface of the thermal conductor and cools heat from the light source.

A video display apparatus in another aspect of the present disclosure includes a light source having a light emitting element, a thermal conductor, an optical system housing, a cooler, and a light bulb. The thermal conductor has a first surface and a second surface, and the light source is thermally connected to the first surface. The optical system housing has a mounting part with an opening. The thermal conductor is fixed to the optical system housing in a state that the first surface is disposed in a direction facing the mounting part and the light emitting element is disposed at a position facing the opening. The cooler is thermally connected to the second surface of the thermal conductor and cools heat from the light source. The light bulb modulates light from the light source according to a video signal for generating video light, and emits the video light.

The light source device of the present disclosure is effective in improving maintainability of the cooler for cooling the light source.

### BRIEF DESCRIPTION OF DRAWINGS

FIG. 1 is a perspective view schematically illustrating an example of an outside appearance of a projector in a first exemplary embodiment;

FIG. 2 is a block diagram schematically illustrating an example of an electrical configuration of the projector in the first exemplary embodiment;

FIG. 3 is a drawing illustrating an example of an optical configuration of the projector in the first exemplary embodiment;

FIG. 4 is a two-view drawing illustrating a configuration example of a phosphor wheel included in the projector in the first exemplary embodiment;

FIG. 5 is an exploded perspective view illustrating a configuration example of peripheries of a cooling module included in the projector in the first exemplary embodiment;

FIG. 6 is a perspective view illustrating a configuration example of a cooling system included in the projector in the first exemplary embodiment;

FIG. 7 is an exploded view schematically illustrating a configuration example of the peripheries of the cooling module included in the projector in the first exemplary embodiment; and

FIG. 8 is a diagram schematically illustrating a state after the peripheries of the cooling module included in the projector in the first exemplary embodiment are assembled.

### DETAILED DESCRIPTION

Hereinafter, exemplary embodiments will be described in detail while appropriately referring to the drawings. However, unnecessarily detailed description may be omitted. For example, detailed description of a matter that has already been well-known or overlapping description of substantially the same configuration may be omitted. This is to avoid unnecessary redundancy of the following description and to facilitate understanding by those skilled in the art.

The accompanying drawings and the following description are provided so that those skilled in the art fully understand the present disclosure. It is not intended that a subject described in the claims be limited by these drawings and description.

In the description, an identical component is denoted by an identical sign, symbol, or number unless otherwise described. Further, unless otherwise described, a component which is not essential in the present disclosure is not illustrated.

### First Exemplary Embodiment

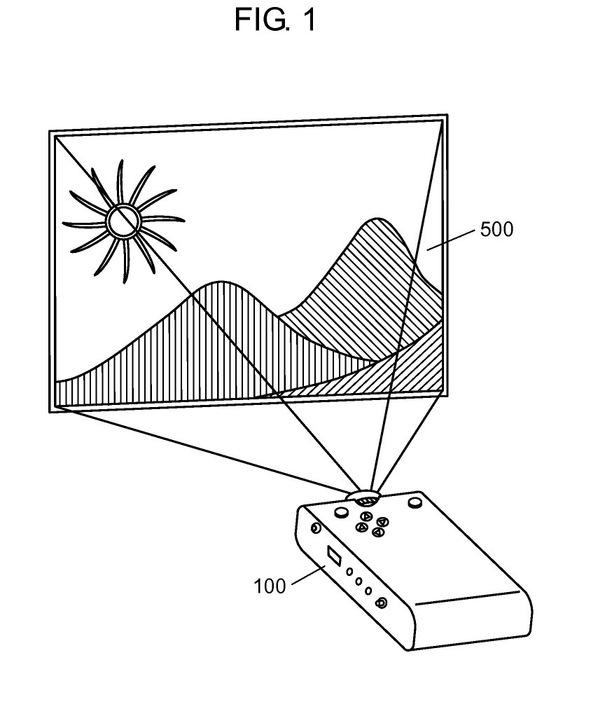

Hereinafter, a first exemplary embodiment will be described with reference to FIGS. 1 to 8.

### [1-1. Overview of Projector 100]

FIG. 1 is a perspective view schematically illustrating an example of an outside appearance of projector 100 in the first exemplary embodiment.

Projector 100 projects onto screen 500 video light generated according to a video signal input from outside. Projector 100 is an example of a video display apparatus.

### [1-1-1. Electrical Configuration]

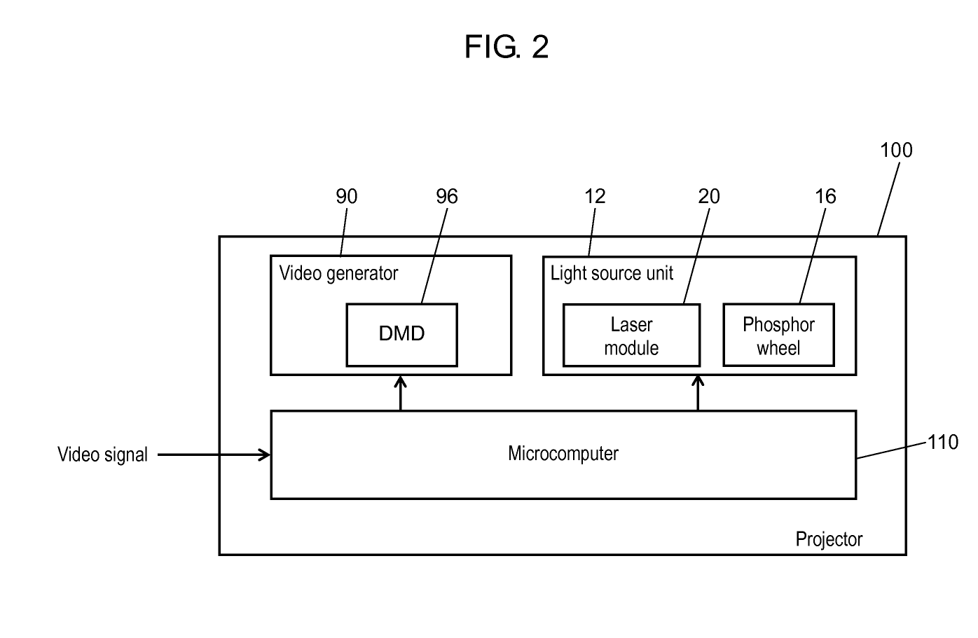

FIG. 2 is a block diagram schematically illustrating an example of an electrical configuration of projector 100 in the first exemplary embodiment.

Projector 100 includes light source unit 12, video generator 90, and microcomputer 110.

Light source unit 12 has laser module 20 and phosphor wheel 16. Light source unit 12 uses light output from laser module 20 as excitation light and causes a phosphor on phosphor wheel 16 to emit fluorescence. Then, the light output from laser module 20 and the light emitted from the phosphor are output to video generator 90. Light source unit 12 is an example of a light source device.

Video generator 90 has a DMD (Digital Mirror Device) 96. Video generator 90 spatially modulates the light output from light source unit 12 according to a video signal input from outside and generates video light. DMD 96 performs this spatial modulation. DMD 96 is an example of a light bulb.

Microcomputer 110 integrally controls entire projector 100 including light source unit 12 and video generator 90. Microcomputer 110 performs various controls by reading out and executing a program previously stored in a ROM (Read Only Memory, not illustrated). Microcomputer 110 synchronously controls the light emission of laser module 20, rotation of phosphor wheel 16, and driving of DMD 96.

### [1-1-2. Optical Configuration]

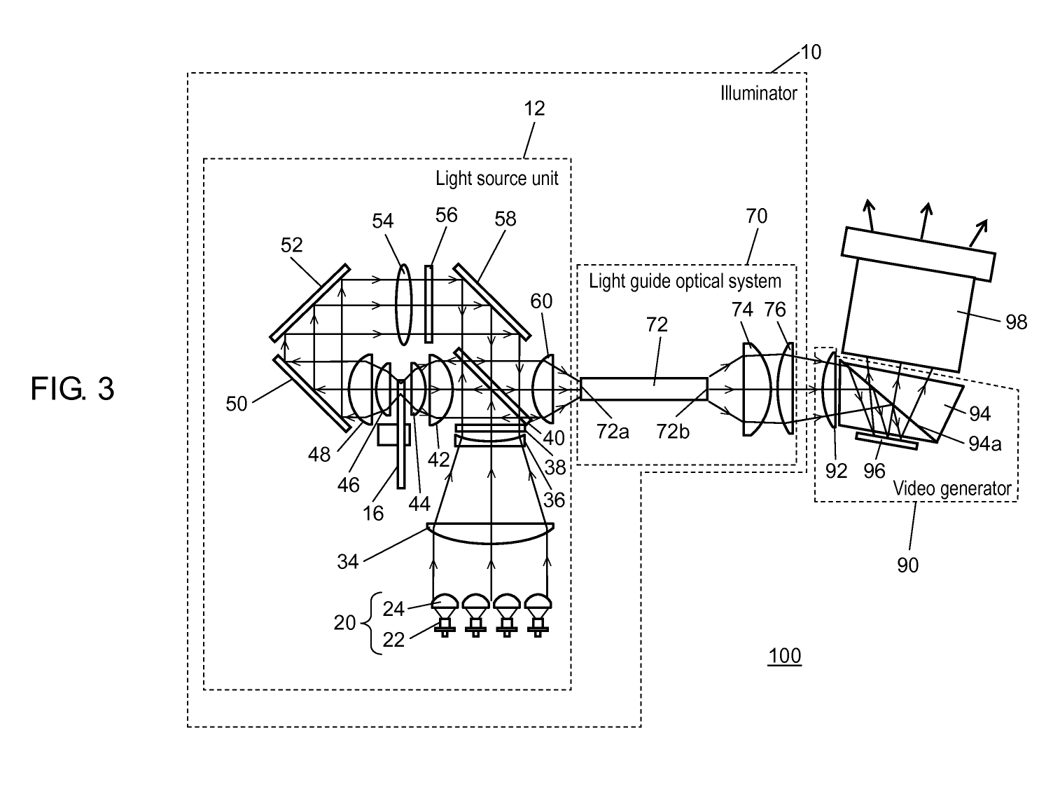

FIG. 3 is a drawing illustrating an example of an optical configuration of projector 100 in the first exemplary embodiment. In FIG. 3, a progressive route of light is indicated by an arrow.

Projector 100 includes illuminator 10, video generator 90, and projection lens 98.

Illuminator 10 includes light source unit 12 and light guide optical system 70, and is configured to irradiate video generator 90 with substantially uniform and nearly collimated light.

First, a configuration of light source unit 12 will be described.

Light source unit 12 includes laser module 20, lenses 34, 36, 42, 44, 46, 48, 54, 60, diffuser plates 38, 56, dichroic mirror 40, phosphor wheel 16, and mirrors 50, 52, 58.

Laser module 20 includes semiconductor laser element 22 and lens 24. Laser module 20 is an example of a light source.

Semiconductor laser elements 22 are arranged in a matrix form of 4×4, and each semiconductor laser element 22 outputs blue laser light having a wavelength of 450 nm. Semiconductor laser element 22 is an example of a light emitting element. A number of semiconductor laser elements 22 is not limited to 16, and an arrangement of semiconductor laser elements 22 is not limited to the matrix form of 4×4. Further, the laser light output from semiconductor laser element 22 is not limited to blue laser light having a wavelength of 450 nm.

Lens 24 is provided at each of semiconductor laser elements 22 and condenses the laser light with a spread angle emitted from semiconductor laser element 22 into a substantially parallel light flux.

Liquid-cooling type cooling module 150, which will be described later, is provided on a rear surface side of laser module 20 (a side opposite to an emitting direction of the laser light). A configuration of cooling laser module 20 by cooling module 150 will be described later.

The laser light (the blue light) emitted from laser module 20 is condensed by lens 34. The light condensed by lens 34 passes through lens 36 and diffuser plate 38. Lens 36 returns the light condensed by lens 34 to a parallel light flux again. Diffuser plate 38 reduces coherence of the laser light and adjusts a light condensing property of the laser light.

Dichroic mirror 40 is a color synthesizing element in which a cutoff wavelength is set at about 480 nm. In other words, dichroic mirror 40 is configured to reflect blue light and to transmit red light and green light. The laser light (the blue light) substantially collimated by lens 36 is reflected by dichroic mirror 40 and passes through lenses 42, 44. Then, phosphor wheel 16 is irradiated with the laser light. The laser light with which phosphor wheel 16 is irradiated is condensed by lenses 42, 44.

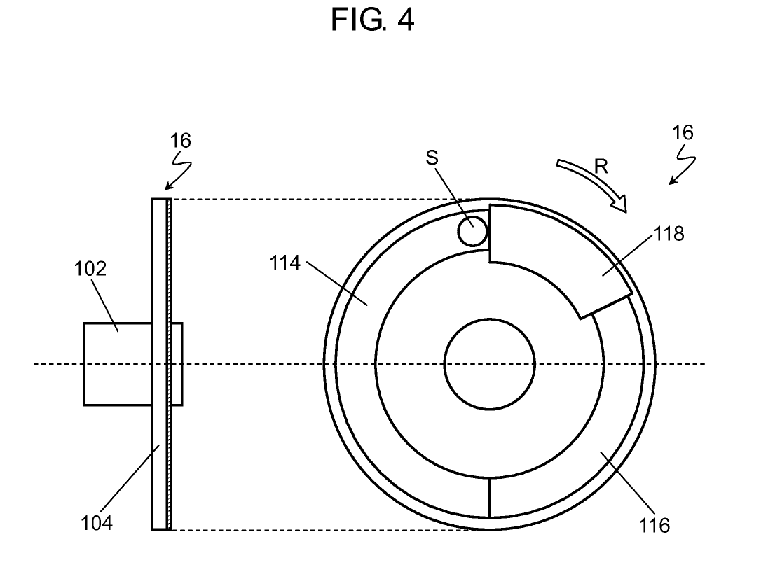

Then, phosphor wheel 16 will be described with reference to FIG. 4

FIG. 4 is a two-view drawing illustrating a configuration example of phosphor wheel (a phosphor substrate) 16 included in projector 100 in the first exemplary embodiment. FIG. 4 illustrates a side view (a drawing illustrated on a left side in FIG. 4) and a plan view (a drawing illustrated on a right side in FIG. 4) of phosphor wheel 16. The side view illustrated in FIG. 4 is a drawing when phosphor wheel 16 is seen from the same viewpoint as in FIG. 3. Further, the plan view illustrated in FIG. 4 is a drawing when phosphor wheel 16 illustrated in the side view in FIG. 4 is seen from a right side of a paper surface.

Phosphor wheel 16 includes disk-shaped aluminum substrate 104. Aluminum substrate 104 is a disk whose surface is coated with a high-reflection coating. Phosphor wheel 16 is disposed in light source unit 12 so that a disk surface of aluminum substrate 104 is vertical to an optical axis of the irradiated laser light. Aluminum substrate 104 is mounted to motor 102 and rotatable in a rotation direction R. A rotation speed at this time is, for example, 60 revolutions per second. However, aluminum substrate 104 may be rotated at a different speed. Then, as mentioned above, the laser light reflected by dichroic mirror 40 is condensed by lenses 42, 44, and phosphor wheel 16 is irradiated with the laser light.

Aluminum substrate 104 of phosphor wheel 16 has a plurality of segments on a circumference irradiated with the laser light in the rotation direction (a circumferential direction) R. Specifically, phosphor wheel 16 has, as segments, phosphor region 114, phosphor region 116, and cut-away region 118 serving as a cut-away through-hole. Phosphor region 114, phosphor region 116, and cut-away region 118 are disposed on phosphor wheel 16 along the rotation direction R in an order of phosphor region 114, cut-away region 118, and phosphor region 116. When phosphor wheel 16 rotates in the rotation direction R, phosphor region 114, phosphor region 116, and cut-away region 118 are sequentially irradiated with the laser light (the blue light).

A phosphor for emitting red light having a dominant wavelength of 610 nm by light having a wavelength of about 450 nm is applied to phosphor region 114. A phosphor for emitting green light having a dominant wavelength of 550 nm by light having a wavelength of about 450 nm is applied to phosphor region 116. The laser light with which cut-away region 118 is irradiated is transmitted as it is to an opposite side. In other words, the light emitted from cut-away region 118 becomes blue light.

Description is continued by returning to FIG. 3. Among the laser light with which phosphor wheel 16 is irradiated, the laser light with which phosphor region 114 is irradiated is converted into red light, and the laser light with which phosphor region 116 is irradiated is converted into green light. Since phosphor wheel 16 is rotated in the rotation direction R, the red light is generated in phosphor wheel 16 in a period during which phosphor region 114 is irradiated with the laser light, and the green light is generated in phosphor wheel 16 in a period during which phosphor region 116 is irradiated with the laser light. A part of these red light and green light is emitted from the surface of the phosphor to the laser light (the blue light) with which phosphor wheel 16 is irradiated, and another part of the red light and green light is reflected by phosphor wheel 16. In this way, the emitted light of the phosphor (the red light and the green light) proceeds in a direction opposite to the laser light (the blue light) with which phosphor wheel 16 is irradiated. Then, these red light and green light are collimated by lenses 44, 42, return to dichroic mirror 40, and pass through dichroic mirror 40.

On the other hand, the laser light with which phosphor wheel 16 is irradiated passes through cut-away region 118 in a period during which cut-away region 118 is irradiated with the laser light. In order to return the laser light (the blue light) passed through phosphor wheel 16 to dichroic mirror 40 again, mirrors 50, 52, 58 are disposed on a light path. The laser light passed through phosphor wheel 16 is collimated by lenses 46, 48, is reflected by respective mirrors 50, 52, 58, and is returned to dichroic mirror 40. Lens 54 and diffuser plate 56 are disposed between mirrors 52 and 58. As illustrated in FIG. 3, the light path of the laser light (the blue light) is extended longer than light paths of the red light and the green light. Lens 54 is a lens for relaying the blue light whose light path is extended. Diffuser plate 56 is disposed to further reduce coherence of the laser light.

The laser light (the blue light) passed through phosphor wheel 16, reflected by respective mirrors 50, 52, 58, relayed on the light path, and returned to dichroic mirror 40 is reflected by dichroic mirror 40. In this way, the light path of the laser light (the blue light) passed through phosphor wheel 16 and the light paths of the fluorescence (the red light and the green light) reflected by phosphor wheel 16 are spatially synthesized by dichroic mirror 40. As described above, phosphor wheel 16 includes the plurality of segments and sequentially emits the light having different wavelengths (the blue light, the red light, the green light) while switching in time division by rotation.

The light synthesized by dichroic mirror 40 is collimated by lens 60 and emitted from light source unit 12 to become emitted light of light source unit 12. The emitted light from light source unit 12 (i.e., light from phosphor wheel 16) enters light guide optical system 70.

Next, light guide optical system 70 will be described. Light guide optical system 70 is configured so as to guide the light emitted from light source unit 12 to video generator 90.

Light guide optical system 70 includes rod integrator 72 and lenses 74, 76.

The emitted light from light source unit 12 enters rod integrator 72. Rod integrator 72 includes incident surface 72a and emitting surface 72b. The emitted light from light source unit 12 made incident on incident surface 72a of rod integrator 72 is output from emitting surface 72b after illuminance of the light is further equalized within rod integrator 72. The light emitted from emitting surface 72b of rod integrator 72 is relayed by lenses 74, 76 and emitted from light guide optical system 70. In this way, the light emitted from light guide optical system 70 becomes output light of illuminator 10 and enters video generator 90.

Video generator 90 includes lens 92, total reflection prism 94, and one DMD 96. Video generator 90 is configured so as to spatially modulate the light emitted from light guide optical system 70 according to a video signal to generate video light.

Lens 92 causes the output light from illuminator 10 to form an image on DMD 96. The light made incident on total reflection prism 94 via lens 92 is reflected by surface 94a and guided to DMD 96.

The light made incident on DMD 96 (the output light from illuminator 10) is not the mixed light of three colors of blue light, red light, and green light. As mentioned above, the incident light is light of time-divided three colors and light in which blue light, red light, and green light are sequentially switched.

DMD 96 includes a plurality of micro mirrors according to a number of pixels and is controlled by microcomputer 110. Microcomputer 110 controls DMD 96 according to timing of light of each color incident on each of the plurality of mirrors included in DMD 96 and according to the video signal. In this way, the output light from illuminator 10 is spatially modulated by DMD 96 and becomes video light according to the video signal. The light (the video light) emitted from DMD 96 passes through total reflection prism 94 and is guided to projection lens 98. This video light is video light in which blue video light, red video light, and green video light are sequentially switched and is video light in which video light of three colors is temporally multiplexed and generated.

Illuminator 10 and video generator 90 are configured as described above. The light emitted from phosphor wheel 16 enters DMD 96. DMD 96 modulates the light emitted from phosphor wheel 16 according to the video signal and emits the generated video light.

Projection lens 98 projects the video light generated by video generator 90 (the video light in which the video light of three colors is temporally multiplexed and synthesized) onto screen 500 outside the apparatus.

Projection lens 98 is an example of a projection optical system.

### [1-2. Operation]

Operation of projector 100 configured as described above will be described.

In projector 100, illuminator 10 outputs the light of three colors of red light, green light, and blue light which are sequentially switched temporally. Video generator 90 generates the video light from the light output from illuminator 10. Projection lens 98 projects the generated video light onto screen 500.

Specifically, in a period during which the red light enters DMD 96, microcomputer 110 controls DMD 96 based on a red video signal included in the video signal. With this configuration, the red video light based on the red video signal is projected onto screen 500. Similarly, the green video light and the blue video light are sequentially projected onto screen 500. In this way, the video light of three colors which are sequentially switched temporally is projected onto screen 500. By continuously viewing the video light projected onto screen 500, a user visually recognizes the video on screen 500 as a color video.

### [1-3. Configuration of Laser Module and Peripheries of Cooling Module]

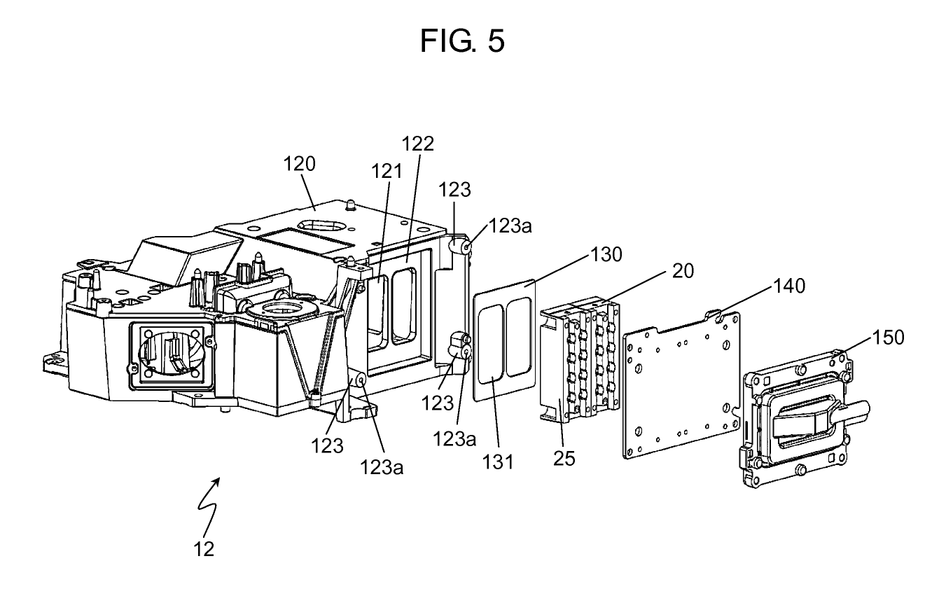

FIG. 5 is an exploded perspective view illustrating a configuration example of peripheries of cooling module 150 included in projector 100 in the first exemplary embodiment. FIG. 5 illustrates the exploded perspective view of laser module 20 of light source unit 12 and the peripheries of cooling module 150 in the present exemplary embodiment.

In addition to the optical configuration illustrated in FIGS. 3 and 4, light source unit 12 of projector 100 includes illumination optical system housing 120, dust-proof sheet 130, heat spreader 140, and cooling module 150. Illumination optical system housing 120 stores in its inside respective optical components of light source unit 12 other than laser module 20. Illumination optical system housing 120 has opening 121 for entering the light emitted from laser module 20. As will be described later, opening 121 is closed by mounting laser module 20 to opening 121. Further, illumination optical system housing 120 has an opening for emitting the light emitted from light source unit 12 to an outside of illumination optical system housing 120 (the opening is not illustrated). This opening is closed by mounting lens 60 of light source unit 12 to the opening. By closing the respective openings, illumination optical system housing 120 has a structure in which the inside of illumination optical system housing 120 is sealed.

Illumination optical system housing 120 has seating surface 122 for closely adhering to laser module 20 via dust-proof sheet 130. Seating surface 122 is provided in illumination optical system housing 120 so as to face a surface of laser module 20 that emits the laser light (hereinafter referred to as an “emitting surface”). Seating surface 122 is an example of a mounting part.

Illumination optical system housing 120 has opening 121 at a position of seating surface 122 that faces semiconductor laser elements 22 when laser module 20 is mounted. The light emitted from semiconductor laser elements 22 enters the inside of illumination optical system housing 120 through opening 121.

Further, illumination optical system housing 120 has four bosses 123 for mounting heat spreader 140 to a periphery of seating surface 122 (one of the bosses is not illustrated). Boss 123 is an example of a mounting part for mounting heat spreader 140.

Laser module 20 includes laser holder 25. Laser holder 25 holds plural pairs of semiconductor laser elements 22 and lenses 24 (not illustrated).

Dust-proof sheet 130 is a gasket formed of an elastic material, such as rubber, in a sheet shape. Dust-proof sheet 130 may be formed of an elastic material other than rubber, such as a synthetic resin having elasticity.

Dust-proof sheet 130 is disposed so as to be sandwiched between seating surface 122 of illumination optical system housing 120 and a surface of laser holder 25 of laser module 20 on the emitting surface side. Dust-proof sheet 130 sandwiched between the seating surface 122 and the surface of laser holder 25 is deformed and closely adhered to the respective surfaces. Accordingly, a gap between the two surfaces is filled. With this configuration, opening 121 of illumination optical system housing 120 is sealed by laser module 20 and dust-roof sheet 130.

Dust-proof sheet 130 has opening 131 so that the light emitted from semiconductor laser elements 22 can enter the inside of illumination optical system housing 120. Dust-proof sheet 130 has opening 131 at a position that faces semiconductor laser elements 22 when laser module 20 is mounted.

Heat spreader 140 is formed of a metal plate having high thermal conductivity, such as copper. Heat spreader 140 may be formed of a material other than copper as long as the material has high thermal conductivity. Heat spreader 140 conducts to cooling module 150 heat generated when semiconductor laser elements 22 of laser module 20 emit light. Specifically, heat generated in semiconductor laser elements 22 is first conducted to laser holder 25, is conducted from laser holder 25 to heat spreader 140, and is conducted from heat spreader 140 to cooling module 150. Heat spreader 140 is an example of a thermal conductor.

Heat spreader 140 is formed in a flat plate shape. In the present exemplary embodiment, one surface of heat spreader 140 (a surface hidden in FIG. 5) serves as a first surface, and a surface of heat spreader 140 on a side opposite to the first surface (a surface illustrated in FIG. 5) serves as a second surface.

The first surface of heat spreader 140 is configured so as to be able to fix laser module 20 by screwing. Laser module 20 is fixed to the first surface of heat spreader 140 so that a surface of laser holder 25 on a side opposite to the emitting surface of semiconductor laser elements 22 (hereinafter referred to as a “rear surface”) closely adheres to heat spreader 140. With this configuration, laser module 20 is thermally connected to the first surface of heat spreader 140.

The second surface of heat spreader 140 is configured so as to be able to fix cooling module 150 by screwing. By screwing cooling module 150 to the second surface of heat spreader 140, cooling module 150 is thermally connected to the second surface of heat spreader 140. Since cooling module 150 is screwed to the second surface of heat spreader 140, cooling module 150 is detachable from heat spreader 140.

Further, heat spreader 140 is screwed to apical surfaces 123a of bosses 123 in a state in which the first surface is disposed in a direction facing seating surface 122. Accordingly, heat spreader 140 is fixed to illumination optical system housing 120 in a state in which seating surface 122 and laser module 20 face each other.

A structure for mounting heat spreader 140 to illumination optical system housing 120 (screws) and a structure for mounting cooling module 150 to heat spreader 140 (screws) are independent of each other. Moreover, cooling module 150 is detachably fixed to heat spreader 140. Therefore, while heat spreader 140 is fixed to illumination optical system housing 120, cooling module 150 can be removed from and mounted again to heat spreader 140.

Cooling module 150 is thermally connected to laser module 20 via heat spreader 140. Cooling module 150 is a member for absorbing heat generated in laser module 20 and is one of members configuring cooling system 170 for cooling laser module 20. Cooling module 150 is an example of a cooler. Next, cooling system 170 will be described.

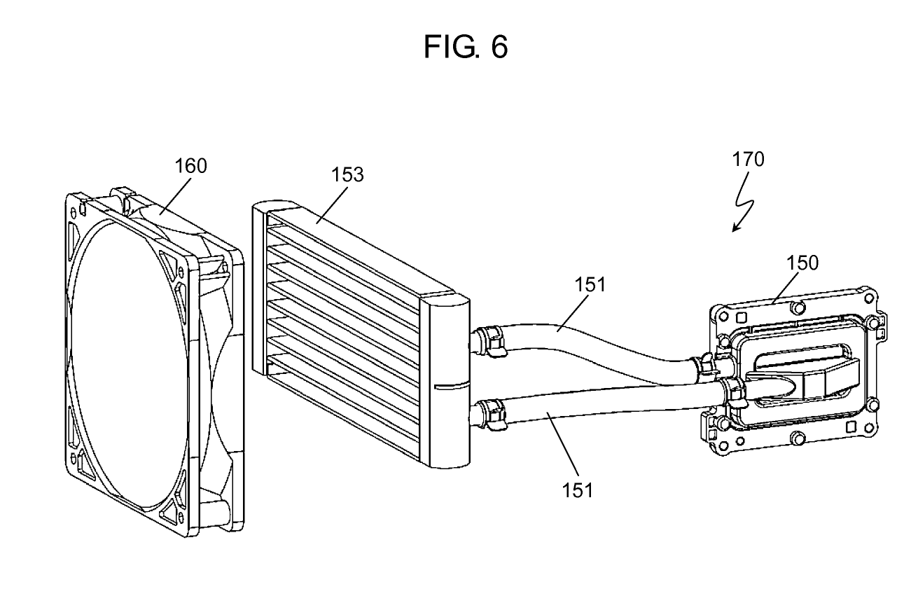

FIG. 6 is a perspective view illustrating a configuration example of cooling system 170 included in projector 100 in the first exemplary embodiment.

Cooling system 170 includes cooling module 150, radiator 153, pipe 151, and fan 160.

Cooling module 150 and radiator 153 are connected by pipes 151. A coolant is circulated between cooling module 150 and radiator 153 by a pump (not illustrated) through pipes 151.

Fan 160 is disposed facing radiator 153. Air outside of projector 100 is blown to radiator 153 by rotation of fan 160.

The heat generated in laser module 20 is absorbed by the coolant via cooling module 150. The heated coolant is moved to radiator 153, is cooled by the air blown by fan 160, and is moved again to cooling module 150. In this way, cooling system 170 performs heat exchange and cools laser module 20. By cooling laser module 20, reduction in luminous efficiency of semiconductor laser element 22 and performance degradation of semiconductor laser element 22 are prevented.

Next, mounting of the peripheral components of cooling module 150 will be described.

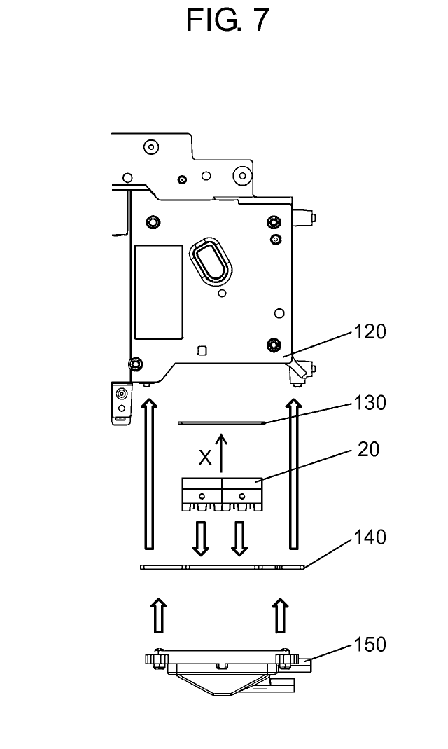

FIG. 7 is an exploded view schematically illustrating a configuration example of the peripheries of cooling module 150 included in projector 100 in the first exemplary embodiment. In FIG. 7, a mounting direction of each peripheral component of cooling module 150 is indicated by an outlined arrow, and an X-axis direction is indicated by a solid line arrow. The X-axis direction is a direction in which laser module 20 emits the laser light and a direction parallel to the optical axis of the laser light (i.e., an optical axis direction).

First, laser module 20 is mounted to the first surface of heat spreader 140. With this configuration, laser module 20 and heat spreader 140 are thermally connected to each other. Next, heat spreader 140 is mounted to apical surfaces 123a of bosses 123 of illumination optical system housing 120 with the first surface facing toward illumination optical system housing 120. At this time, dust-proof sheet 130 is sandwiched between seating surface 122 of illumination optical system housing 120 and laser module 20. Eventually, cooling module 150 is mounted to the second surface of heat spreader 140. With this configuration, cooling module 150 and heat spreader 140 are thermally connected to each other.

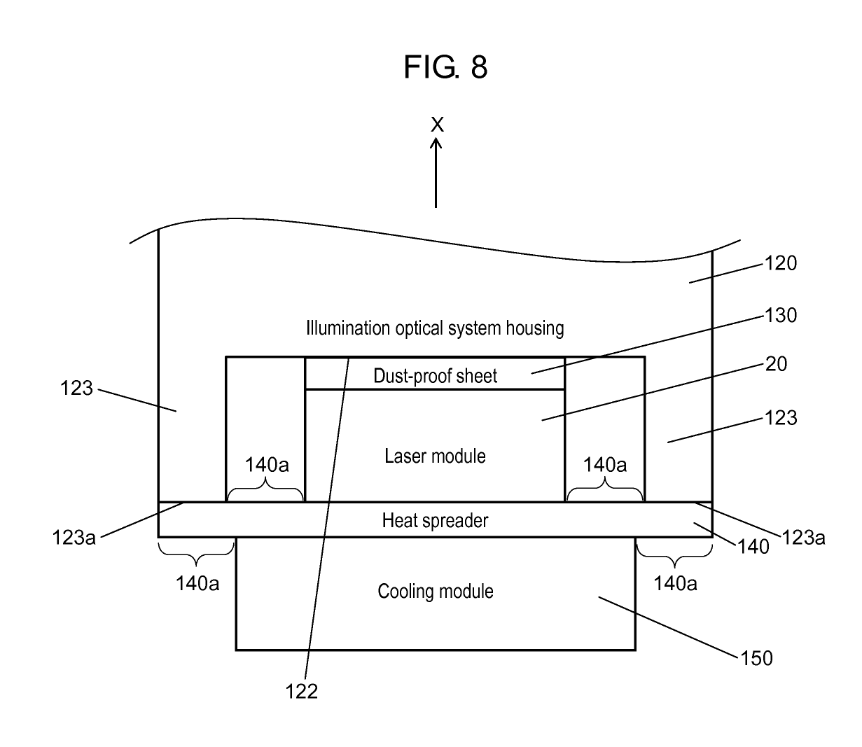

FIG. 8 is a diagram schematically illustrating a state after the peripheries of cooling module 150 included in projector 100 in the first exemplary embodiment are assembled. In FIG. 8, an X-axis direction is indicated by an arrow. The X-axis direction in FIG. 8 is the same direction as the X-axis direction in FIG. 7 and a direction parallel to the optical axis of the laser light.

As illustrated in FIG. 8, heat spreader 140, to which laser module 20 is mounted, is mounted to bosses 123 of illumination optical system housing 120. Moreover, dust-proof sheet 130 is sandwiched between seating surface 122 of illumination optical system housing 120 and the surface of laser module 20 on the emitting surface side.

At this time, it is desirable that dimensions of the respective components are set so that, when appropriate assembling of the respective components is finished, dust-proof sheet 130 moderately adheres to seating surface 122 of illumination optical system housing 120.

In illumination optical system housing 120, a variation may occur in a positional relationship (a distance) between apical surface 123a of boss 123 and seating surface 122, to which dust-proof sheet 130 is mounted, in the X-axis direction. Further, a variation may occur in an outside dimension of laser module 20.

Moreover, when a total of a thickness of laser module 20 and a thickness of dust-proof sheet 130 before the assembling is excessively larger than a length from seating surface 122 to the first surface of heat spreader 140 after the assembling, heat spreader 140 may not be mounted at a proper position or dust-proof sheet 130 may be broken at the time of assembling. Further, when the total of the thickness of laser module 20 and the thickness of dust-proof sheet 130 before the assembling is smaller than the length from seating surface 122 to the first surface of heat spreader 140 after the assembling, a gap is generated between dust-proof sheet 130 and seating surface 122 after the assembling, and dust-proof performance in illumination optical system housing 120 may be degraded.

Accordingly, in the present exemplary embodiment, the thickness of dust-proof sheet 130 is set to satisfy the following condition. In other words, regardless of the above-described dimensional variations, the total of the dimension (the thickness) of laser module 20 and the dimension (the thickness) of dust-proof sheet 130 in a natural state (before the assembling) in the X-axis direction of laser module 20 is slightly larger than the length from seating surface 122 to the first surface of heat spreader 140 after the assembling.

At this time, when the thickness of dust-proof sheet 130 is too large or too small, the above-described problems may occur. Therefore, the thickness of dust-proof sheet 130 is set to an extent that dust-proof sheet 130 elastically deforms moderately between seating surface 122 and laser module 20 after the assembling.

By setting in this way, when heat spreader 140 is fixed to bosses 123, dust-proof sheet 130 is compressed to deform elastically. With this configuration, the above-described variations are absorbed. Further, with this configuration, opening 121 of illumination optical system housing 120 is sealed by dust-proof sheet 130 and laser module 20, and dust-proofness of the inside of illumination optical system housing 120 is secured.

Heat spreader 140 in the present exemplary embodiment is formed of the flat plate-shaped member. Accordingly, the length from seating surface 122 to the first surface of heat spreader 140 is substantially the same as a length from seating surface 122 to apical surface 123a of boss 123. Therefore, the above-described condition can be restated as follows. The thickness of dust-proof sheet 130 may be set to satisfy the following condition. In other words, regardless of the above-described dimensional variations, the total of the dimension (the thickness) of laser module 20 and the dimension (the thickness) of dust-proof sheet 130 in the natural state (before the assembling) in the X-axis direction of laser module 20 is slightly larger than the length from seating surface 122 to apical surface 123a of boss 123.

For example, the thickness of dust-proof sheet 130 in the natural state (before the assembling) in the X-axis direction is set to about 1 mm, and the length from seating surface 122 to the emitting surface of laser module 20 after the assembling is set to about 0.8 mm. In this case, dust-proof sheet 130 is sandwiched between seating surface 122 and the emitting surface of laser module 20 in a state of being compressed by about 20%. These numerical values are merely examples, and the present disclosure is not limited at all by these numerical values.

Further, in the present exemplary embodiment, laser module 20 is directly mounted to the first surface of heat spreader 140, and cooling module 150 is directly mounted to the second surface of heat spreader 140. In other words, laser module 20 is thermally connected to cooling module 150 via heat spreader 140. Therefore, cooling module 150 can efficiently cool laser module 20.

Further, in the present exemplary embodiment, the structure for mounting heat spreader 140, to which laser module 20 is mounted, to illumination optical system housing 120 and the structure for mounting cooling module 150 to heat spreader 140 are independent of each other. Accordingly, when cooling module 150 (entire cooling system 170) is replaced or repaired due to, for example, a fault, cooling module 150 can be removed from heat spreader 140 without removing laser module 20 and heat spreader 140 from illumination optical system housing 120. If laser module 20 is removed from and mounted again to illumination optical system housing 120, dust-proof performance of illumination optical system housing 120 may be degraded. However, as mentioned above, in projector 100 in the present exemplary embodiment, it is not necessary to remove laser module 20 from illumination optical system housing 120 when cooling module 150 is replaced. In other words, since cooling module 150 alone can be removed from heat spreader 140, maintainability of cooling module 150 can be improved while keeping dust-proofness of illumination optical system housing 120.

As illustrated in the example in FIG. 8, in addition to a region for mounting laser module 20 and cooling module 150, heat radiation region 140a for radiating heat from laser module 20 may be provided in heat spreader 140.

### [1-4. Effects and Others]

As described above, in the present exemplary embodiment, the light source device includes the light source having the light emitting element, the thermal conductor, the optical system housing, and the cooler. The thermal conductor has the first surface and the second surface, and the light source is thermally connected to the first surface. The optical system housing has the mounting part with the opening. The thermal conductor is fixed to the optical system housing in a state that the first surface is disposed in the direction facing the mounting part and the light emitting element is disposed at the position facing the opening. The cooler is thermally connected to the second surface of the thermal conductor and cools the heat from the light source.

This light source device may include the dust-proof sheet formed of an elastic material and sandwiched between the mounting part and the light source.

In this light source device, the thickness of the dust-proof sheet in the natural state may be set so that the total of the thickness of the light source and the thickness of the dust-proof sheet in the natural state in the optical axis direction of the light source is longer than the length from the mounting part to the first surface of the thermal conductor.

In this light source device, the thermal conductor may include the heat radiation region for radiating the heat from the light source in addition to the region thermally connecting the light source and the cooler.

In this light source device, the cooler can be detachable from the second surface of the thermal conductor while the thermal conductor is fixed to the optical system housing.

Further, in the present exemplary embodiment, the video display apparatus includes the light source having the light emitting element, the thermal conductor, the optical system housing, the cooler, and the light bulb. The thermal conductor has the first surface and the second surface, and the light source is thermally connected to the first surface. The optical system housing has the mounting part with the opening. The thermal conductor is fixed to the optical system housing in a state that the first surface is disposed in the direction facing the mounting part and the light emitting element is disposed at the position facing the opening. The cooler is thermally connected to the second surface of the thermal conductor and cools the heat from the light source. The light bulb modulates the light from the light source according to the video signal for generating video light, and emits the video light.

Projector 100 is an example of the video display apparatus. Light source unit 12 is an example of the light source device. DMD 96 is an example of the light bulb. Laser module 20 is an example of the light source. Semiconductor laser element 22 is an example of the light emitting element. Seating surface 122 is an example of the mounting part. Heat spreader 140 is an example of the thermal conductor. Cooling module 150 is an example of the cooler. Illumination optical system housing 120 is an example of the optical system housing. Opening 121 is an example of the opening. Dust-proof sheet 130 is an example of the dust-proof sheet. Heat radiation region 140a is an example of the heat radiation region.

A product life cycle of the semiconductor laser element is relatively long and is about 20,000 hours or more. Therefore, in the projector including the semiconductor laser element as the light source, the cooling device (e.g., cooling module 150) may fail earlier than the light source (e.g., laser module 20).

In a conventional projector in which a light source and a cooling device are directly connected to each other, when the cooling device is replaced or repaired, it is necessary to remove the light source together with the cooling device from an optical system housing.

However, if the light source is removed from the projector, a part of the optical system housing sealed so far is opened, and dust or dirt may enter an inside of the optical system housing. This may degrade optical performance of the projector. Alternatively, when the light source is mounted again to the optical system housing, small displacement may occur at an arrangement position of a dust-proof sheet, and dust-proof performance may also be degraded than before. In such a case, for example, thermal conductive grease may enter the inside of the optical system housing by an optical dust collection effect, and optical performance of the projector may also be degraded. Further, when the cooling device is mounted again to the light source, a degree of adhesion between the cooling device and the light source may be reduced than before, and performance of cooling the light source may also be degraded.

However, in the video display apparatus including the light source in the example illustrated in the present exemplary embodiment, only the cooling device can be removed from and mounted again to the optical system housing without removing the light source from the optical system housing.

For example, in projector 100, only cooling module 150 can be removed from and mounted again to illumination optical system housing 120 without removing laser module 20 from illumination optical system housing 120. Since a replacement work of cooling module 150 can be performed without removing laser module 20, a maintenance work of cooling module 150 can be performed without exposing the inside of illumination optical system housing 120 to the outside air. Therefore, it is possible to prevent degradation of dust-proof performance of illumination optical system housing 120 and to improve maintainability of cooling module 150.

Further, since laser module 20 is directly fixed to the first surface of heat spreader 140 and cooling module 150 is directly fixed to the second surface of heat spreader 140, laser module 20 and cooling module 150 are thermally connected to each other via heat spreader 140. With this configuration, the performance equivalent to that of the conventional technique can be secured also for the cooling performance of laser module 20.

Further, in the present exemplary embodiment, laser module 20 is mounted to heat spreader 140, and heat spreader 140, to which laser module 20 is mounted, is mounted to illumination optical system housing 120 with dust-proof sheet 130 in between. For example, laser module 20 can be directly mounted to illumination optical system housing 120. However, in that configuration, at the time of mounting laser module 20 including a plurality of laser holders 25 to illumination optical system housing 120, if there are variations in outside dimensions of laser holders 25, rear surface sides of laser holders 25 become irregular, and it becomes difficult to uniformly adhere the rear surfaces of laser holders 25 to heat spreader 140. However, in the present exemplary embodiment, since laser module 20 is first mounted to heat spreader 140, even if there are variations in the outside dimensions of laser holders 25, the rear surfaces of laser holders 25 can be substantially uniformly adhered to heat spreader 140. On the other hand, if dust-proof sheet 130 is absent when there are variations in the outside dimensions of laser holders 25 and the emitting surface sides of laser holders 25 are irregular, a gap is generated between laser module 20 and seating surface 122, and the dust-proof performance of illumination optical system housing 120 is degraded. However, in the present exemplary embodiment, since elastically deformable dust-proof sheet 130 is sandwiched between the emitting surface of laser holder 25 and seating surface 122, even if the emitting surface sides of laser holders 25 are irregular, dust-proof sheet 130 is elastically deformed and absorbs the variations. Accordingly, the dust-proof performance of illumination optical system housing 120 can be secured.

### Other Exemplary Embodiments

As described above, the first exemplary embodiment has been described as an illustration of the technique disclosed in the present application. However, the technique in the present disclosure is not limited to this and is applicable to an exemplary embodiment where modifications, replacements, additions, omissions, or the like are performed. Further, a new exemplary embodiment can be provided by combining the respective components described in the above-described first exemplary embodiment.

Accordingly, the other exemplary embodiments will be illustrated below.

In the first exemplary embodiment, the configuration in which opening 121 of illumination optical system housing 120 is sealed by laser module 20 and dust-proof sheet 130 has been described. However, sealing of opening 121 of illumination optical system housing 120 is not limited to the configuration of using laser module 20 and dust-proof sheet 130. For example, it is possible to have a configuration in which a mounting part of illumination optical system housing 120 is formed in a recessed shape so as to match a shape of laser module 20 and in which laser module 20 directly fits into this recessed mounting part without sandwiching dust-proof sheet 130. In this configuration, dust-proof performance of illumination optical system hosing 120 can be secured without adhering laser module 20 to illumination optical system housing 120. However, as illustrated in the first exemplary embodiment, it is more desirable to have the configuration of using dust-proof sheet 130 to enhance dust-proof performance of illumination optical system housing 120.

In the first exemplary embodiment, description has been given of a configuration in which heat spreader 140 is formed of the flat plate-shaped member and the one surface serves as the first surface and the other surface serves as the second surface. However, heat spreader 140 is not limited to this configuration at all. For example, heat spreader 140 may be formed of a plate-shaped member bent into an L-shape. Moreover, it is possible that one surface serves as a first surface and another surface sandwiching a bent part serves as a second surface. In this case, heat generated from laser module 20 mounted to the first surface is conducted to cooling module 150 via the first surface, the bent part, and the second surface.

As illustrated in the example in FIG. 8, heat radiation region 140a for radiating heat from laser module 20 may be provided at heat spreader 140. Further, a heat radiation member, such as a radiation fin, formed of a material having high thermal conductivity, such as copper, may be mounted to heat radiation region 140a. Alternatively, a groove for radiation may be provided in heat radiation region 140a.

In the first exemplary embodiment, liquid-cooling type cooling system 170 has been described as an example of the cooler. However, cooling system 170 may be of an air-cooling type. Alternatively, it is possible to have a configuration in which a heat radiation member, such as a radiation fin, formed of a material having high thermal conductivity, such as copper, is mounted to heat spreader 140 and air is blown to the heat radiation member. In a case of this configuration, there is a possibility that rust is generated in copper and heat radiation performance is deteriorated. However, in the present embodiment, only the rusted radiation fin can be removed from heat spreader 140 and replaced.

In the first exemplary embodiment, a configuration in which laser module 20 includes one laser holder 25 has been described. However, laser module 20 may include a plurality of laser holders 25. In such a case, dimensions of the plurality of laser holders in a thickness direction may be different from one another within a range of dimensional tolerance. However, since the respective laser holders are fixed to heat spreader 140 even in such a case, every laser holder can conduct heat to heat spreader 140. Further, variations in the dimensions of the respective laser holders can be absorbed by dust-proof sheet 130.

In the first exemplary embodiment, a configuration in which the respective optical components of light source unit 12 other than laser module 20 are stored inside illumination optical system housing 120 has been described. However, in addition to light source unit 12, components other than light source unit 12 may be stored inside illumination optical system housing 120 as long as illumination optical system housing 120 has a structure capable of sealing the optical components and protecting the inside against dust. For example, illumination optical system housing 120 may have a structure for storing and sealing inside a part or all of light source unit 12, light guide optical system 70, and video generator 90. At this time, an opening serving as an inlet for light and an opening serving as an outlet for light may be closed by mounting any of the components configuring the projector. With this configuration, illumination optical system housing 120 can have a dust-proof structure whose inside is sealed while securing the outlet for light and the inlet for light.

In the first exemplary embodiment, DMD 96 is illustrated as an example of the light bulb. However, the light bulb is not limited to DMD 96. The light bulb may be an element for modulating light emitted from illuminator 10 and outputting video light. For example, the light bulb may be a reflection type liquid crystal panel or a transmission type liquid crystal panel.

In the first exemplary embodiment, a thickness of heat spreader 140 has not been mentioned. It is desirable that the thickness of heat spreader 140 is set to an appropriate thickness. For example, when heat spreader 140 is too thick, heat of laser module 20 is not appropriately conducted to cooling module 150 side. On the other hand, when heat spreader 140 is too thin, the heat of laser module 20 is conducted to cooling module 150 side without being sufficiently diffused inside heat spreader 140. Accordingly, heat spreader 140 has heat locally, and a cooling effect of the cooling module is limited. Therefore, it is desirable that the thickness of heat spreader 140 is set so that the heat of laser module 20 is appropriately diffused inside heat spreader 140 and conducted to cooling module 150 side and that the cooling effect of the cooling module can be appropriately obtained.

The present disclosure is applicable to a light source device including a cooling mechanism and a video display apparatus including the light source device. Specifically, the present disclosure is applicable to a liquid crystal system projector, a DLP system projector, or the like.

What is claimed is:

1. A light source device comprising:
a light source including a light emitting element;
a thermal conductor having a first surface and a second surface, the light source being thermally connected to the first surface;
an optical system housing having a mounting part with an opening, and the thermal conductor being fixed to the optical system housing in a state that the first surface is disposed in a direction facing the mounting part and the light emitting element is disposed at a position facing the opening; and
a cooler thermally connected to the second surface and configured to cool heat from the light source.

2. The light source device according to claim 1, further comprising a dust-proof sheet formed of an elastic material and sandwiched between the mounting part and the light source.

3. The light source device according to claim 2, wherein a thickness of the dust-proof sheet in a natural state is set so that a total of a thickness of the light source and the thickness of the dust-proof sheet in the natural state in an optical axis direction of the light source is longer than a length from the mounting part to the first surface.

4. The light source device according to claim 1, wherein the thermal conductor includes a heat radiation region for radiating the heat from the light source in addition to a region thermally connecting the light source and the cooler.

5. The light source device according to claim 1, wherein the cooler is detachable from the second surface of the thermal conductor while the thermal conductor is fixed to the optical system housing.

6. A video display apparatus comprising:
a light source including a light emitting element;
a thermal conductor having a first surface and a second surface, the light source being thermally connected to the first surface;
an optical system housing having a mounting part with an opening, and the thermal conductor being fixed to the optical system housing in a state that the first surface is disposed in a direction facing the mounting part and the light emitting element is disposed at a position facing the opening;
a cooler thermally connected to the second surface and configured to cool heat from the light source; and
a light bulb configured to modulate light from the light source according to a video signal for generating video light, and to emit the video light.

7. The video display apparatus according to claim 6, further comprising a dust-proof sheet formed of an elastic material and sandwiched between the mounting part and the light source.

8. The video display apparatus according to claim 7, wherein a thickness of the dust-proof sheet in a natural state is set so that a total of a thickness of the light source and the thickness of the dust-proof sheet in the natural state in an optical axis direction of the light source is longer than a length from the mounting part to the first surface.

9. The video display apparatus according to claim 6, wherein the thermal conductor includes a heat radiation region for radiating the heat from the light source in addition to a region thermally connecting the light source and the cooler.

10. The video display apparatus according to claim 6, wherein the cooler is detachable from the second surface of the thermal conductor while the thermal conductor is fixed to the optical system housing.
